(19) United States
(12) Patent Application Publication
(10) Pub. No.: US 2012/0137303 A1
(43) Pub. Date: May 31, 2012

(54) COMPUTER SYSTEM

(75) Inventors: Wataru Okada, Machida (JP); Hirokazu Ikeda, Yamato (JP)

(73) Assignee: Hitachi, Ltd.

(21) Appl. No.: 12/996,725

(22) PCT Filed: Nov. 26, 2010
(86) PCT No.: PCT/JP2010/006917

§ 371 Date: Dec. 7, 2010

(51) Int. Cl. G06F 9/50

(52) U.S. Cl. 718/104

(57) ABSTRACT

Provided is a computer system capable of reliably eliminating duplicated data regardless of the size of the data write unit from the host computer to the storage subsystem or the management unit size in the elimination of duplicated data.

This computer system executes the relocation of duplicated data to the storage resource so that the writing of duplicated data is started from the start location of the management unit based on the detection of data redundancy and recognition of the management unit size in the elimination of duplicated data.

### TECHNICAL FIELD

The present invention relates to a computer system, and in particular relates to a storage system so that, even if same data is written from a host computer into a storage subsystem, a storage resource is not redundantly assigned to the same data.

### BACKGROUND ART

A storage system provides a storage area to a host computer, and is known as a type which comprises a storage subsystem including a storage resource and a controller for realizing the control function of data stored in the storage resource, and a management computer.

With a storage subsystem, there is thin provisioning as one type of virtualization technology for efficiently using the capacity of the storage resource. Thin provisioning sets a virtual volume, which is a virtualization of the capacity, in the storage subsystem, and, when a host computer accesses the virtual volume, assigns a storage capacity from the storage resource to the virtual volume.

The storage subsystem additionally realizes de-duplication technology of duplicated data for eliminating duplicated data from the storage resource in order to efficiently use the capacity of the storage resource. Elimination of duplicated data means preventing a storage resource from being redundantly assigned to each of a plurality of same data. Specifically, if same data is written from the host computer to a plurality of areas of the virtual volume, the controller of the storage subsystem is able to efficiently use the storage resource by referring to a common area storing the same data.

The storage subsystem eliminates duplicated data in page capacity units as the virtual volume management unit from the perspective of streamlining the management of the storage resource. Since the management information of data will increase if the management unit in the elimination of duplicated data is of low capacity, the management cost will increase since the capacity of the system memory for storing the management information must be increased. Meanwhile, although the management cost can be reduced if the management unit in the elimination of duplicated data is of high capacity, duplicated data is not eliminated if data in the amount of the capacity of the management unit is not duplicated, and the effect of eliminating duplicated data cannot be achieved sufficiently.

Thus, the storage system according to Japanese Unexamined Patent Application No. 2009-181148A efficiently eliminates duplicated data while preventing the increase in management costs by executing de-duplication in page units to pages to which de-duplication is to be executed, and performing de-duplication in segment units, wherein a segment has a smaller capacity than a page, to pages to which de-duplication is not to be executed.

### CITATION LIST

### Patent Literature

PTL 1: Japanese Unexamined Patent Application No. 2009-181148A

### SUMMARY OF INVENTION

### Technical Problem

If the management unit size in the elimination of duplicated data and the management unit size of writing from the host computer are different as with the de-duplication technology of duplicated data in a conventional storage subsystem, there is a problem in that the elimination of duplicated data is not sufficiently achieved.

Thus, an object of this invention is to provide a computer system capable of reliably eliminating duplicated data regardless of the size of the data write unit from the host computer to the storage subsystem or the management unit size in the elimination of duplicated data.

### Solution to Problem

In order to achieve the foregoing object, the computer system according to the present invention is characterized in that it executes the relocation of duplicated data to the storage resource so that the writing of duplicated data is started from the start location of the management unit based on the detection of data redundancy and recognition of the management unit size in the elimination of duplicated data.

According to the present invention, even if the size of the first management unit in the writing of data from the host computer is smaller than the size of the second management unit in the elimination of duplicated data, the placement of duplicated data in the second management unit will coincide among a plurality of duplicated data, a storage resource is not redundantly assigned to the same data.

### Advantageous Effects of Invention

The present invention yields the effect of being able to provide a computer system capable of reliably eliminating duplicated data regardless of the size of the data write unit from the host computer to the storage subsystem or the management unit size in the elimination of duplicated data.

### BRIEF DESCRIPTION OF DRAWINGS

FIG. 1 is a hardware block diagram according to one mode of the computer system according to the present invention.

FIG. 2 is a block diagram showing an example of a logical system configuration of thin provisioning in the computer system of FIG. 1.

FIG. 3 is an example of a virtual volume management table.

FIG. 4 is an example of a physical page management table.

FIG. 5 is an example of a management table of the logical unit (LU) to be accessed by the host computer.

FIG. 6 is a flowchart showing one mode of the de-duplication processing.

FIG. 7 is a flowchart according to another mode of the de-duplication processing.

FIG. 8 is a block diagram of a storage system showing that the write unit size from the host computer and the de-duplication detection unit size are different.

FIG. 9 is an example of a file management table.

FIG. 10 is an example of a duplicated block management table.

FIG. 11 is an example of a duplicated data management table.

FIG. 12 is a flowchart according to one example of processing for relocating the duplicated data.

FIG. 13 is a flowchart according to one example of the routine for creating a duplicated data management table.

FIG. 14 is a flowchart according to an extended example of the duplicated data relocation processing according to FIG. 12.

FIG. 15 is a virtual volume management table for the second embodiment of the present invention.

FIG. 16 is a flowchart showing the physical page relocation processing in the second embodiment.

FIG. 17 is a flowchart of the page assignment processing for relocating duplicated data in the second embodiment.

FIG. 18 is a block diagram of the duplicated data relocation in the second embodiment.

### DESCRIPTION OF EMBODIMENTS

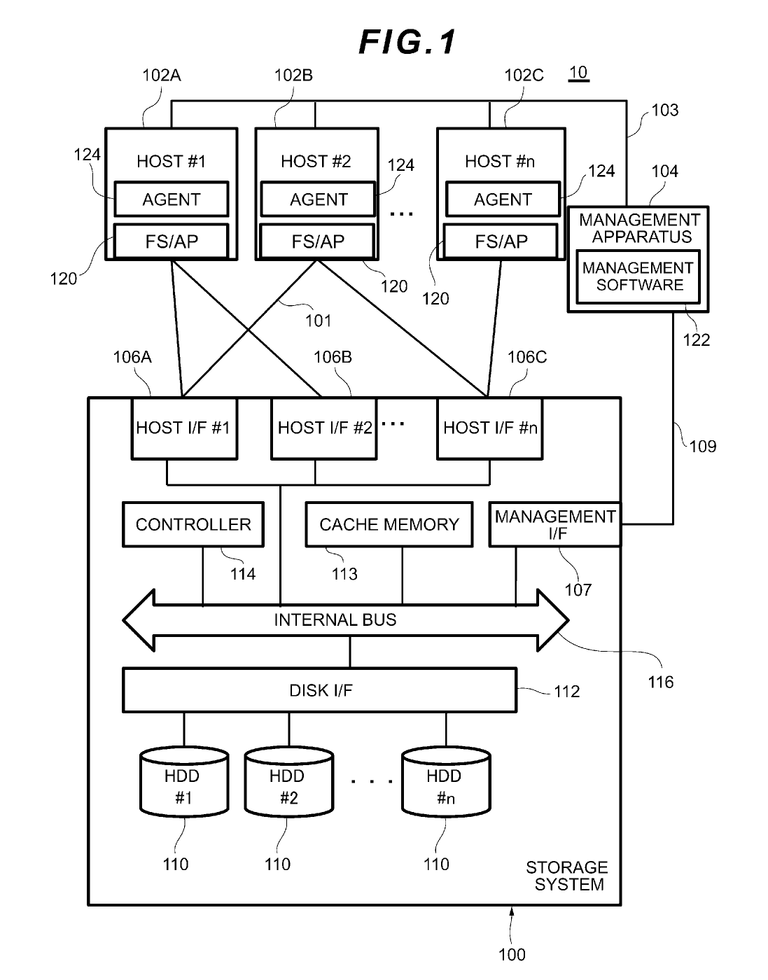

Embodiments of the present invention are now explained with reference to the attached drawings. FIG. 1 is a hardware block diagram according to one mode of the computer system according to the present invention. The computer system 10 comprises a storage subsystem 100, a plurality of host computers 102, and a management computer 104. The management computer 104 is connected to a plurality of host computers 102A . . . with a network 103 such as a wide area communication network.

The storage subsystem 100 comprises a host interface (I/F) 106 for connecting to the host computer 102. The storage subsystem 100 further comprises a management interface 107 for connecting to the management computer 104. The host interface (I/F) 106 controls the sending and receiving of data to and from the host computer 102. The management interface 106 controls the exchange of management information with the management computer 104.

The host interface 106 is connected to the host computer 102 via a network 101 such as a SAN. There are a plurality of host interfaces 106, and a first host interface 106A is connected to a first host computer 102A and a second host computer 102B, a second host interface 106B is connected to the first host computer 102A, and a third host interface 106C is connected to the first host computer 102A and a third host computer 102C. The management interface 107 is connected to the management computer 104 with a network 109 via a LAN or the like.

The storage subsystem 100 comprises a plurality of hard disk drives (HDD) 110 configuring a storage resource. The disk interface (I/F) 112 controls the I/O of data to and from the HDD. The storage subsystem 100 further comprises a cache memory 113 for temporarily storing data, and a controller 114 for executing control processing in relation to the writing of data into the HDD and the reading of data from the HDD.

The controller 114 comprises a CPU for executing the control processing, and a memory for storing control data and management data. The storage subsystem 100 comprises an internal bus 116 for mutually connecting control elements such as the host interface 106 and the controller 114. Note that the host computer 102 and the management computer 104 are configured from a general computer including a CPU, a memory, and an interface for communicating with the storage subsystem 100.

The host computer 102 includes means for using the virtual volume of the storage subsystem 100. This means is configured from a file system or an application (FS/AP) 120 comprising a raw device function of directly reading and writing a virtual volume without going through a file system.

The management computer 104 is loaded with management software 122. The management software implements the management of the configuration of the storage subsystem 100, acquisition of the management information from the host computer 102, and setting of the management information to the host computer 102. The configuration information of the storage subsystem 100 includes a virtual volume management table described later, and a management table of the physical area of the storage resource to be assigned to the virtual volume.

The management computer 104 acquires management information of data from the FS/AP 120 of the host computer 102 and searches for duplicated data, and executes processing for relocating the duplicated data to the storage resource so that the duplicated data will coincide with the management unit of eliminating duplicated data.

The host computer 102 includes an agent 124. The agent 124 receives a command from the management software 122, collects data management information from the file system or application of the host computer, provides the collected data to the management software, receives management information for relocating duplicated data from the management software of the host computer, and supplies the received management information to the file system and the application.

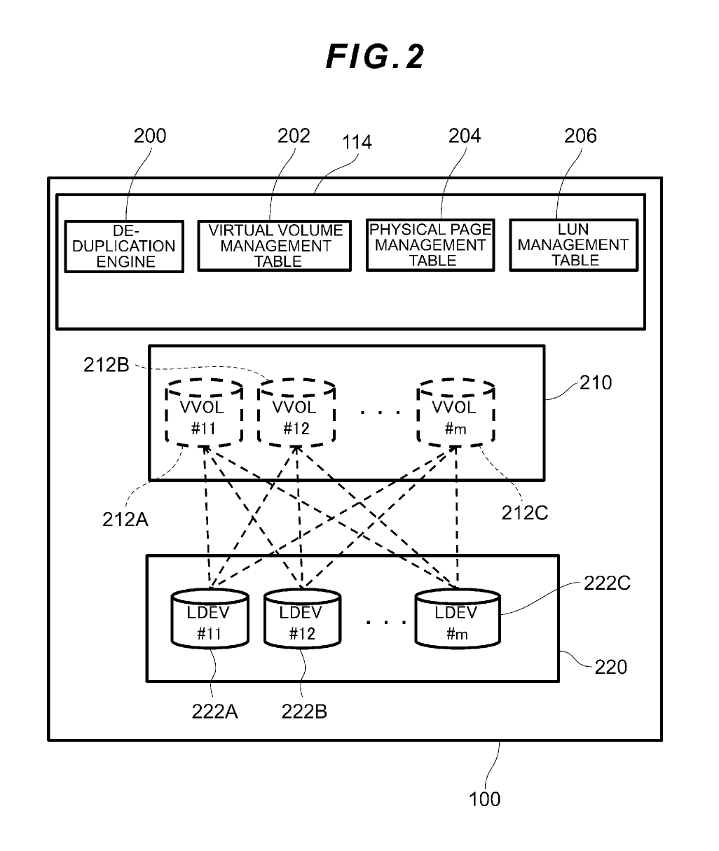

FIG. 2 is a block diagram showing an example of a logical system configuration of thin provisioning in the storage subsystem 100 of FIG. 1. Reference numeral 210 is a virtual volume group configured from a plurality of virtual volumes 212 (212A, 212B, 212C). The host computer 102 executes read/write from and to the virtual volume associated with the LU by accessing the logical unit (LU).

The virtual volume 212 includes the same address space as the logical volume. The host computer 102 recognizes the virtual volume 212 as one logical storage area as with the logical volume. The capacity of the virtual volume 212 is a virtualized volume, and the virtual volume 212 is not assigned with a physical capacity from the storage resource before the writing of data as with the logical volume. Triggered by data being written into the virtual volume, a physical page is assigned from the storage resource to the virtual page of the virtual volume 212. Write data to the virtual page is stored in the physical page.

The reference numeral 220 is a pool including the LDEV; that is, the logical volume 222 (222A, 222B, 222C) to be assigned to the virtual volume 212. The volume 222 is used for assigning the physical capacity of the storage resource to the virtual volume, and the execution program of thin provisioning existing in the controller 114 or the host interface 106 assigns the storage capacity in page units from the volume 222 to the virtual volume 212. Although the volume 222 is not assigned to a specific host computer, since a storage resource is assigned thereto, it is referred to as a real volume or a physical volume in relation to the virtual volume. The real volume is configured by dividing logical areas from a RAID group configured from a plurality of HDDs 110.

Each of the plurality of virtual volumes 212 is associated with a plurality of real volumes 222. Each host computer 102 accesses the virtual volume 212 associated with the logical unit among the plurality of virtual volumes.

The controller 114 comprises a de-duplication engine 200 for eliminating duplicated data in the storage resource. The de-duplication engine 200 is realized by a de-duplication program in the controller. The controller 114 comprises, in its local memory, a virtual volume management table 202, a physical page management table 204, and a LUN (Logical Unit Number) management table 206.

The de-duplication engine 200 refers to the management tables and performs the de-duplication processing of duplicated data. The de-duplication processing of duplicated data is achieved by a plurality of pages of a virtual volume written into duplicated data being assigned to one physical page. The de-duplication engine 200 achieves de-duplication by releasing the mapping to the physical page of the virtual page, and re-mapping the virtual page to another physical page storing the duplicated data. Note that the de-duplication engine may also perform the processing for assigning a real volume page to a virtual volume page.

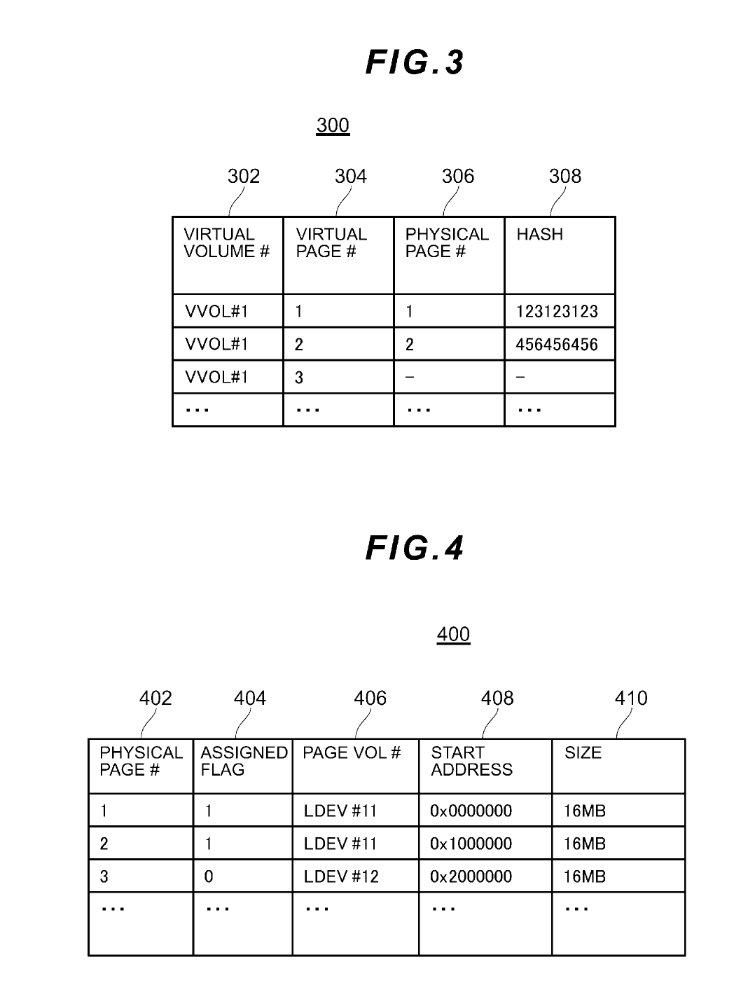

FIG. 3 shows an example of the virtual volume management table 300. The virtual volume # (302) is an identifier of the virtual volume, the virtual page # (304) is an identifier of the virtual page configuring the virtual volume, the physical page # (306) is an identifier of the physical page assigned to the virtual page, “−” means that a physical page has not been assigned to a virtual page, the hash 308 is a hash value of the write data stored in the physical page assigned to the virtual page. The de-duplication engine 200 operates the write data with a hash function and acquires a hash value as a fixed-length value in order to determination the redundancy of write data, and write this into the virtual volume management table 300. Data with the same hash value is subject to de-duplication as duplicated data. Note that the de-duplication engine 200 may also compare the plurality of data themselves to decide whether they are duplicated data.

FIG. 4 shows an example of the physical page management table 400, and is used by the de-duplication engine 200 for managing the physical page assigned to the virtual volume. The physical page # (402) is an identifier of the physical page assigned to the virtual page of the virtual volume 212, the assignment flag 404 is a flag showing whether a physical page has been assigned to a virtual page, wherein “1” shows that it has been assigned and “0” shows that it has not been assigned, the page-use VOL # (406) is an identifier of the real volume 222 including the physical page, the start address 408 is the start address of the physical page in the real volume, and the size 410 is the size of the physical page.

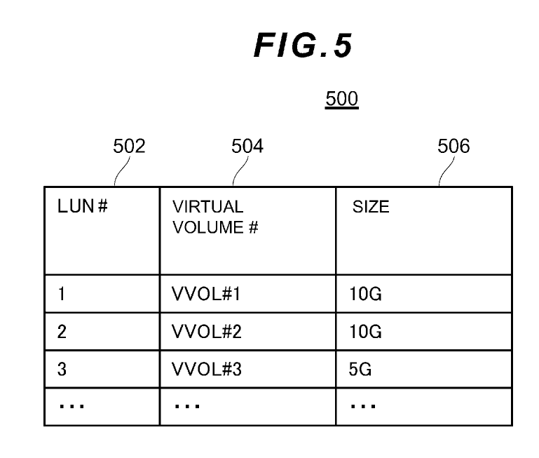

FIG. 5 shows the management table 500 of the logical unit (LU) to be accessed by the host computer. The LUN # (502) is an identifier of the LU recognized by the host computer 102, the virtual volume # (504) is an identifier of the virtual volume 212 assigned to the LU, and the size 504 is the virtualized capacity size of the virtual volume #. The address of the LUN # is the same as the address of the virtual volume # (502).

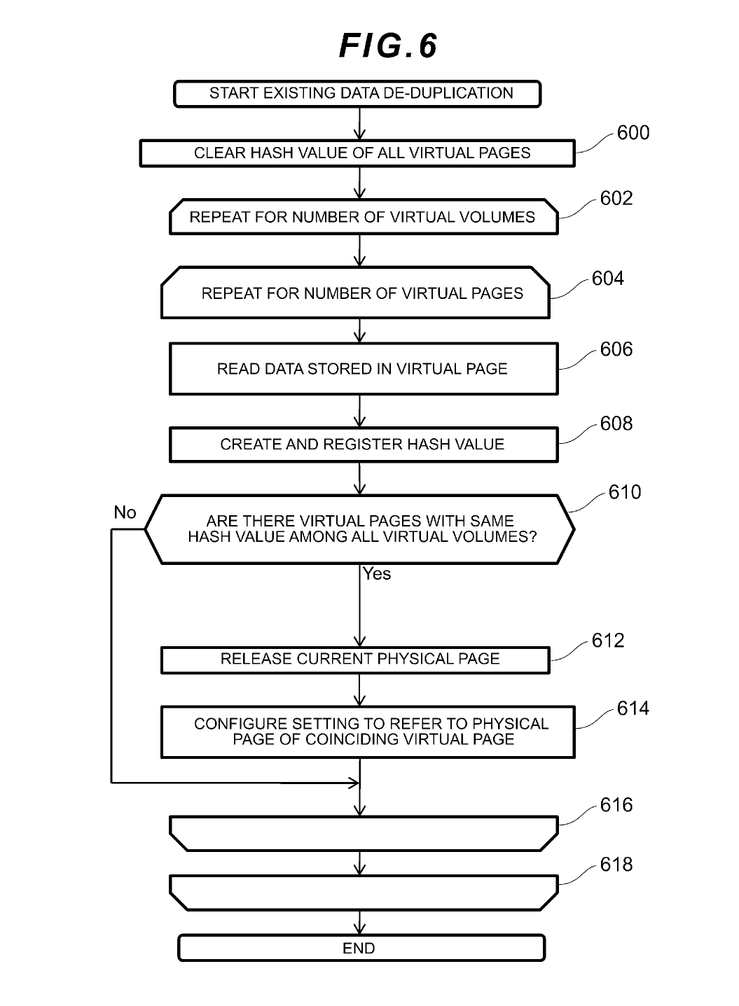

FIG. 6 is a flowchart showing one mode of the de-duplication processing of duplicated data. The de-duplication processing is applied to the write data written from the host computer 102 into the virtual volume 212. This flowchart is executed by a processor in the controller 114 which realizes the de-duplication engine. The controller 114 refers to the virtual volume management table (FIG. 3), and clears the hash value of all virtual pages (step 600). The controller 114 manages the writing into a virtual page using a counter after creating the hash value, and, since there is no change to the hash value if there is no writing, the processing for clearing the hash value of step 600 may be omitted.

The controller 114 repeats the re-computation of the hash value and the processing for eliminating duplicated data based on the recomputed hash value (step 606 to step 614) for the number of plurality of virtual volumes (step 602, step 618). The controller 114 repeats the re-computation of the hash value and the de-duplication processing of duplicated data based on the recomputed hash value (step 606 to step 614) for the number of virtual pages (step 604, step 616).

The controller 114 acquires the identification information 306 of the physical page assigned to the virtual page by referring to the virtual volume management table 300 in order to write data from the host computer 102 to the virtual page, and reads data in the size of the physical page from the start address 408 of the physical page by referring to the physical page management table 400 based on the identification information 306 of the physical page (step 606). The controller 114 skips the virtual pages to which a physical page is not assigned.

The controller 114 computes the hash function and computes the hash value based on the data read from the respective virtual pages, and registers the computed hash value in the virtual volume management table 300 (step 608).

The controller 114 checks whether there is a virtual page with the same hash value as the hash value created at step 608 by referring to the virtual volume management table 300 (step 610). If the controller 114 determines that there is a virtual page with the same hash value, it releases the assignment of the physical page to the check target virtual page (step 612), and assigns the physical page with the same hash value to the check target virtual page.

The controller 114 refers to the virtual volume management table 300 and updates the physical page # corresponding to the check target virtual page to the physical page # with the same hash value (step 614). If the controller 114 obtains a negative result in the determination at step 610, the controller 114 skips step 612 and step 614. Note that, if the controller 114 determines that there is a possibility of hash collision upon checking the match or mismatch of the hash value among a plurality of data, it may choose to compare the data themselves.

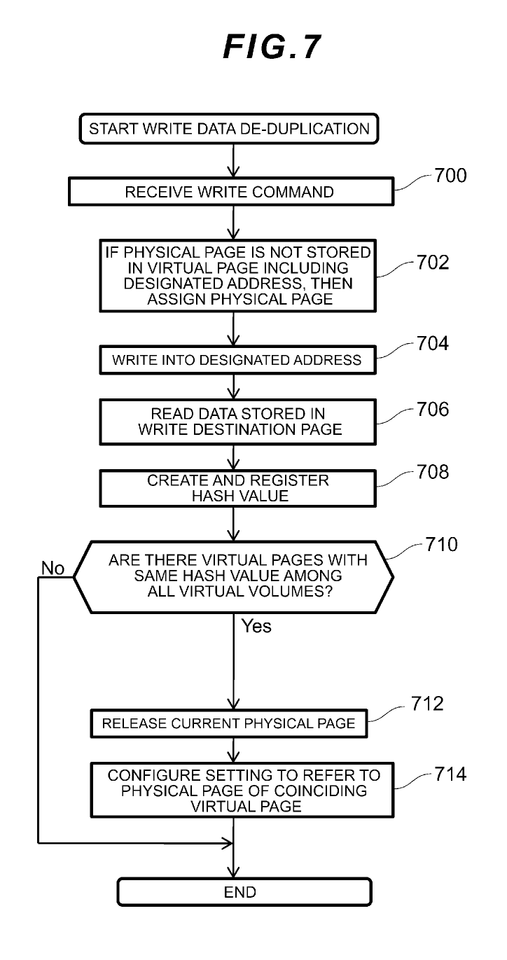

FIG. 7 is a flowchart of another mode of the de-duplication processing. Unlike the flowchart of FIG. 6, the de-duplication engine 200 starts the de-duplication processing triggered by the writing from the host computer 102. When the controller 114 receives write processing from the host computer 102 (step 700), it receives the write destination LUN, the write destination address, and the write data from the host computer 102.

The controller 114 identifies the virtual volume 212 corresponding to the LUN from the LUN management table 500, refers to the virtual volume management table 300, and newly assigns a physical page if a physical page is not assigned to the virtual page corresponding to the access area from the host computer 102 of the virtual volume 212 (step 702). This is not necessary if the physical page has been assigned.

Subsequently, the controller 114 writes the data received from the host computer 102 into the address of the physical page assigned to the virtual page (step 704). The controller 114 thereafter reads data from the physical page storing the data (step 706), and further computes the hash value of the data and registers the computed hash value in the virtual volume management table 300 (step 708).

The controller 114 determines whether there is a virtual page with the same hash value among all virtual volumes 212 as the hash value computed at step 708 (step 710), and, upon obtaining a positive result in the foregoing determination, releases the assignment of the physical page to that virtual page (step 712), assigns a physical page storing the duplicated data with the same hash value to the virtual page, and registers the identification information of the physical page storing the duplicated data in the virtual page of the virtual volume management table 300 (step 714).

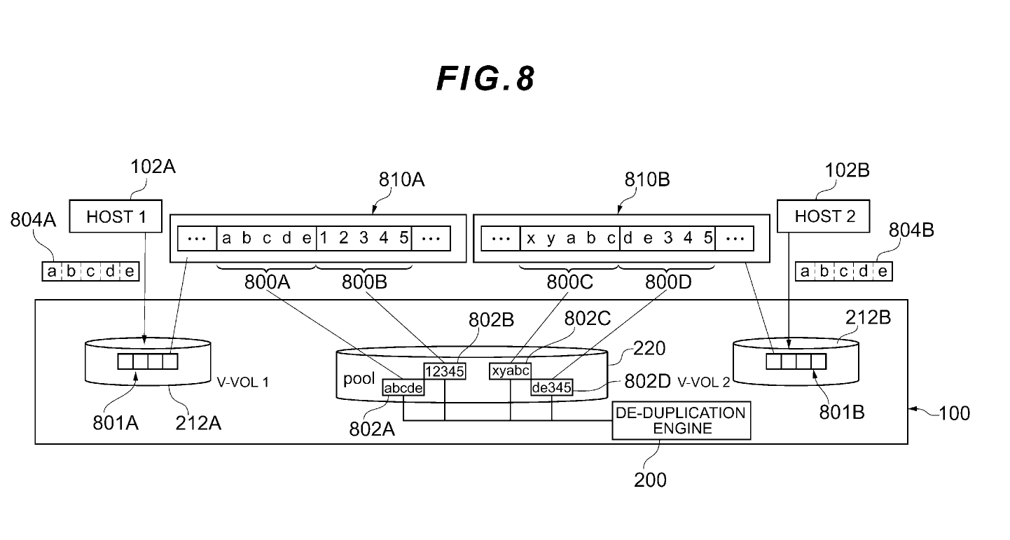

The management unit size of the writing from the host computer to the storage subsystem is, for example, 4 KB, and the page size as the management unit of de-duplication in the storage subsystem is, as described above, 16 MB or 42 MB. If the management unit size of writing from the host computer and the management unit size of de-duplication of duplicated data are different and, for example, the size of the latter is greater than the size of the former, even if the write data are mutually the same, the placement of data in the page will not coincide, and there is a problem in that the storage subsystem 100 is unable to detect that it is the same data and the de-duplication processing of duplicated data cannot be achieved. This is explained with reference to FIG. 8.

In FIG. 8, [abcde] (804A) is written in order from the host 1 (102A) to the virtual volume (V-VOL) 1 (212A). Each of the [abcde] is data corresponding to a write unit. The same data (804B) is written from the host 2 (102B) to the virtual volume 2 (212B). The pool 220 has a physical page assigned to the virtual page of the virtual volume. 801A is a plurality of virtual pages of the virtual volume 1 (212A), and 801B is a plurality of virtual pages of the virtual volume 2 (212B).

Reference numeral 810A is an enlargement of the virtual page of the virtual volume 1 (212A), data configured from [abcde] is set in the virtual page 800A, and data configured from [12345] is set in the virtual page 800B. Reference numeral 802A is the physical page assigned to the virtual page 800A, stores data configured from [abcde], and reference numeral 802B is the physical page assigned to the virtual page 800B, and stores data configured from [12345]. The virtual page 800A corresponds to the first de-duplication unit, and the virtual page 800B corresponds to the second de-duplication unit.

Reference numeral 810B is an enlargement of the virtual page of the virtual volume 2 (212B), and data configured from [xyabc] is set in the virtual page 800C, and data configured from [de123] is set in the virtual page 800D. Reference numeral 802C is the physical page assigned to the virtual page 800C and stores data configured from [xyabc], and reference numeral 802D is the physical page assigned to the virtual page 800D and stores data configured from [de123]. The virtual page 800C corresponds to the third de-duplication unit and the virtual page 800D corresponds to the fourth de-duplication unit.

The placement of data in the first de-duplication unit 800A is [abcde], and the sequence of data in the second de-duplication unit 800B is [12345]. The sequence of data in the third de-duplication unit 800C is [xyabc], and the alignment of data in the fourth de-duplication unit 800D is [de345]. Consequently, even though the write data 804A from the host computer 1 (102A) and the write data 804B of the host computer 2 (102B) are the same as [abcde], since the data alignment in the de-duplication unit is a mismatch, the de-duplication engine 200 of the storage subsystem is unable to achieve the de-duplication processing of duplicated data.

Thus, the management software 122 of the management computer 104 acquires management information concerning data written from the host computer 102 to the storage subsystem 100 and detects duplicated data, thereafter creates a command for relocating the duplicated data in the storage resource so that the placement mode of the duplicated data in the de-duplication unit will coincide, and runs this in the host computer 102. When the host computer 102 writes the duplicated into the virtual volume according to the command from the management computer 104, the de-duplication engine 200 of the storage subsystem is able to perform de-duplication processing of duplicated data to such duplicated data. This processing is now explained with reference to a flowchart.

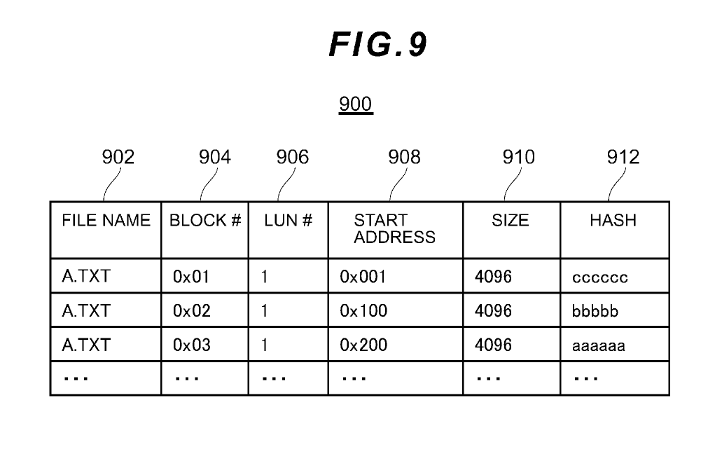

Prior to explaining the flowchart, the management table that is used in the duplicated data de-duplication processing is explained. FIG. 9 shows an example of the file management table 900. The management computer 104 acquires management information of the file information from the respective host computers 102 from the agent 124, and creates the file management table 900 based thereon.

The file name 902 is the name of the file being managed by the file system 120 of the respective host computers 102, and normally shows only the file name for simplification although it includes the directory name. The block # 904 is the identification number of one of more file blocks configuring the file, the LUN # (906) is the volume of the host computer 102 storing the file, the start address 908 is the address in the volume shown with the LUN #, the size 910 is the size of the file block, and the hash 912 is the hash value of the data stored in the file block. If the file system is ZFS, ZFS automatically creates the hash value of SHA 256 when writing is performed from the host computer 102 to the storage subsystem 100. If the file system 120 does not create a hash value, the agent 124 creates the hash value. The management computer 104 stores the file management table 900.

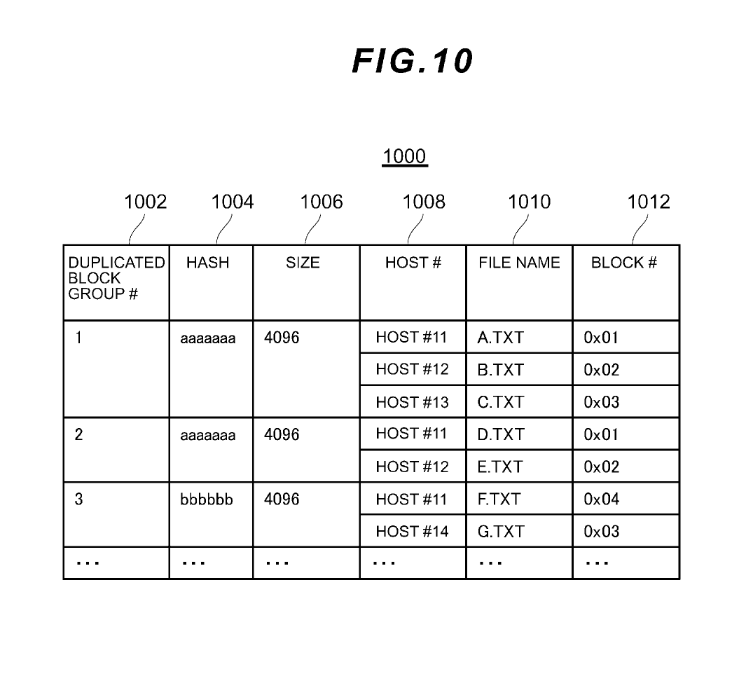

The management software 122 of the management computer refers to the file management table, and verifies the existence of duplicated data for each file block. The management program summarizes the file management information for each duplicated block in the duplicated block management table. FIG. 10 shows an example of the duplicated block management table 1000, and the duplicated block group # (1002) is the ID of the block group in which the data is redundant, the hash 1004 is the hash value of the data stored in the block, the size 1006 is the size of the block, the host # (1008) is the identifier of the host computer with the duplicated data, the file name 1010 is the file name with the block storing the duplicated data, and the block # (1012) is the ID of the block storing the duplicated data among the files shown with the file name.

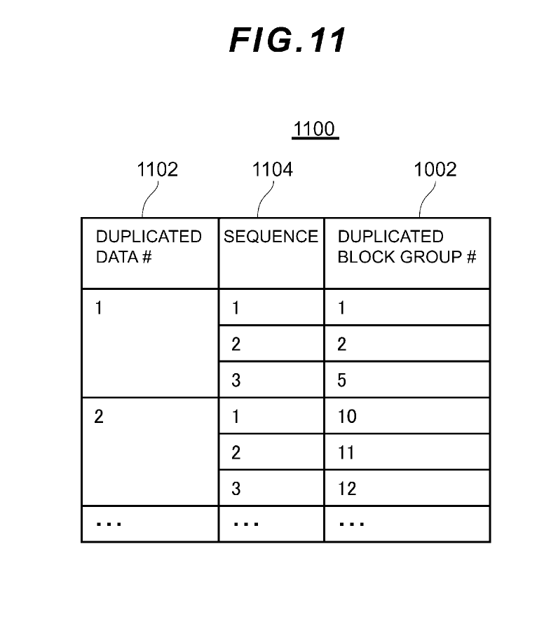

The management program 122 of the management computer 104 creates a management table, based on the duplicated block management table 1000, for relocating the duplicated data to the storage resource in order to eliminate the duplicated data in the storage subsystem 100. FIG. 11 shows an example of the duplicated data management table 1100, and defines the order that the host computer 102 is to write the duplicated data in the storage subsystem 100. The duplicated data # (1102) is the ID of the duplicated data, the order 1104 is the order that the duplicated data stored in one or more duplicated block groups is to be written into the storage subsystem, and the duplicated block group # (1002) is the ID of the duplicated block group storing the duplicated data stored in the one or more duplicated block groups (FIG. 10).

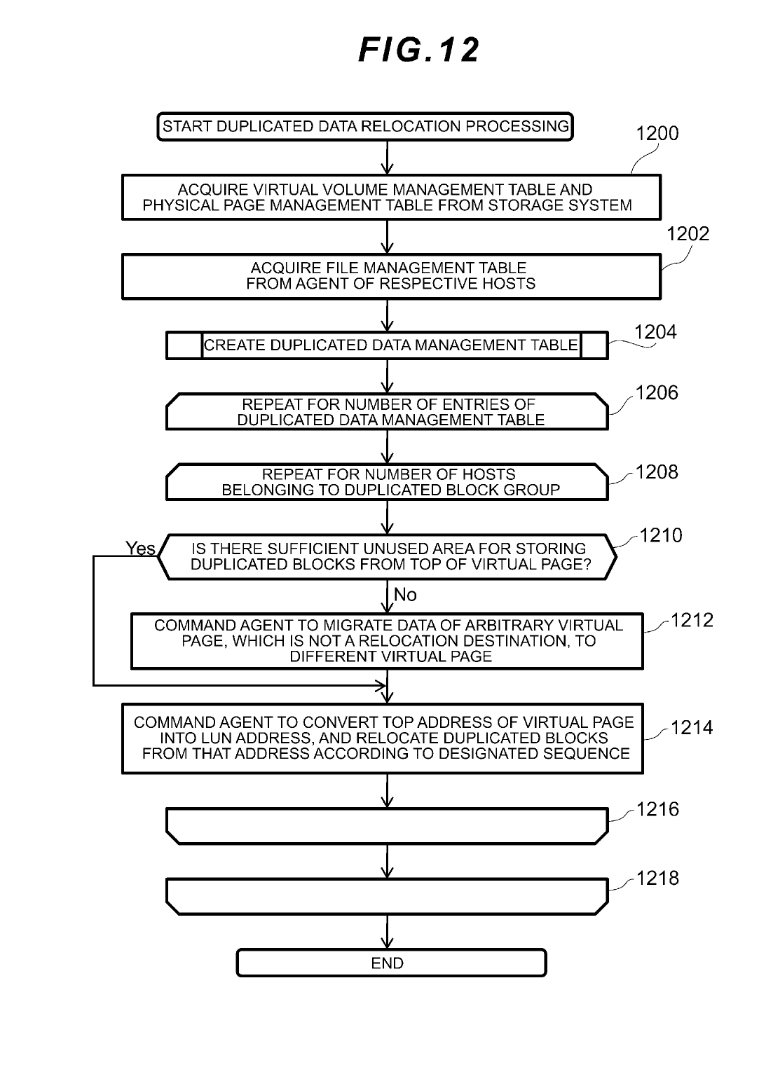

FIG. 12 is a flowchart showing an example of the processing for relocating the duplicated data. The management computer 104 executes the flowchart based on the management software 122. This flowchart is started based on a command from the management user to the management software, or a command from the scheduler. The management computer 104 acquires, from the storage subsystem 100, the management information of the virtual volume management table 300 and the physical page management table 400 (step 1200).

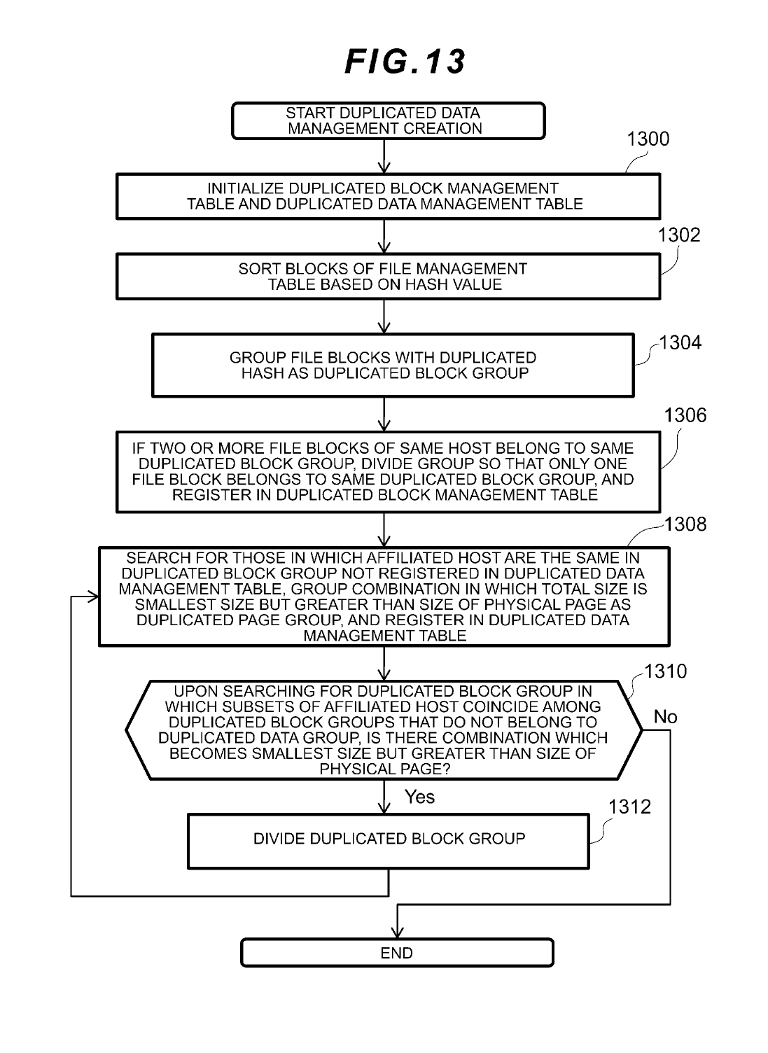

The management computer 104 additionally acquires the file management table from the respective host computers 102 via the agent (step 1202). Subsequently, the management computer 104 creates the duplicated data management table 1100 (step 1204). The routine for achieving this is shown in the flowchart of FIG. 13. In the flowchart of FIG. 13, when the management computer 104 starts the creation of the duplicated data management table, it initializes the duplicated block management table 1000 and the duplicated data management table 1100 by deleting all entries of these tables (step 1300).

The management computer 104 sorts the hash values of the file management table 900 based on quick sort or the like (step 1302), groups the file blocks for each redundant hash value as a duplicated block group (step 1304), and registers the duplicated block group in the duplicated block management table 1000.

If the de-duplication program is running on the host computer 102 based on a file system such as ZFS; that is, if the file blocks storing the duplicated data in the host computer 102 are consolidated into a single area, the management computer 104 selects one arbitrary file block among the plurality of file blocks and deletes the remainder from the duplicated block management table 1000.

In addition to determining whether the comparison target data is the same based on the hash value, the management computer 104 may also acquire information regarding in which address of the virtual volume the file block is written, and cause the de-duplication engine 200 of the storage subsystem 100 to confirm whether the data stored in the acquired address is a match. Here, if the de-duplication engine 200 is only able to detect the duplication of fixed-length page data, it is also possible to confirm duplication by temporarily writing the duplicated data from the top of an unassigned physical page, and creating fixed-length data by filling addresses behind the data end with 0.

At step 1306, if there is a block of the same host computer 102 in the duplicated block group that was grouped at step 1304, the management computer 104 divides this into separate groups so that two or more file blocks of the same host computer 102 will not exist in the same group, and registers the duplicated block group in the duplicated block management table 1000. To explain this with reference to FIG. 10, the duplicated block group with the hash value of [aaaaaaa] includes a block of 0x01 of A.TXT of the host #11, a block of 0x01 of D.TXT of the host #11, a block of 0x01 of the B.TXT of the host #12, a block of 0x02 of E.TXT of the host #12, and a block of 0x01 of C.TXT of the host #13.

Thus, in order to prevent the two files blocks of the host #11 and the two file blocks of the host #12 from belonging to the same duplicated block group, the management computer 104 divides the duplicated block group with the hash value of [aaaaaaa] into two groups as shown in FIG. 10. If the duplicated block of the same host computer is registered in the duplicated block group, the host computer will write the duplicated block in the same position of the virtual volume based on a command from the management computer. Specifically, data duplicated in a plurality of positions is de-duplicated from the perspective of the host computer. This will succeed if the host computer is equipped with a de-duplication function, but this will fail with a host computer that does not have the de-duplication function. Thus, the duplicated block of the same host computer is not registered in the same group. Note that, if the management computer determines whether the host computer has the de-duplication function and the host computer is equipped with the de-duplication function, the foregoing file block may be registered in the same group.

The management computer 104, at step 1308, refers to the duplicated block management table 1000, and specifies those in which the host computer belonging to the duplicated block group is the same regarding the duplicated block groups not registered in the data management table 1100. Subsequently, the management computer 104 decides a combination where the total size of a plurality of duplicated block groups among the specified duplicated block groups is the size of the physical page, or the smallest size but greater than the size of the physical page, and registers this in the duplicated data management table 1100 as the group (1102) of the duplicated data #. This can be illustrated as follows by using FIG. 11.

Duplicated data #1:

Duplicated block group 1: Duplicated data [aaaaaaa]

Host #11 A.TXT 0x01

Host #12 B.TXT 0x02

Host #13 C.TXT 0x03

Duplicated block group 2: Duplicated data [bbbbbbb]

Host #11 D.TXT 0x01

Host #12 E.TXT 0x02

Host #13 F.TXT 0x03

Duplicated block group 5: Duplicated data [ccccccc]

Host #11 G.TXT 0x01

Host #12 H.TXT 0x02

Host #13 I.TXT 0x03

The reason why the management computer 104 classifies the duplicated block groups with the same host computers belonging to the duplicated block group to one duplicated data # group is as follows. When relocating duplicated data, the management computer indicates only the top address to the host computer. The host computer places data in order. Thus, if a different host computer enters midway, that host computer will not know where to write the data.

At step 1310, the management computer 104 searches for those that coincide with the subset of the host computers belonging to the duplicated block group, and determines whether the total size of the duplicated block group will be greater than the physical page size. If the management computer 104 obtains a positive result in the determination at this step, it proceeds to step 1312, separates the subset of the host computers from the duplicated block group, and returns to step 1104. For example, in FIG. 10, the duplicated block group #1 has the host #11, the host #12, and the host #13, and the duplicated block group #2 has the host #11, and the host #12. Thus, the management computer 104 divides the duplicated block group #11 into a combination of the host #11 and the host #12, and the host #13, and registers the former and the duplicated block group 2 in the duplicated data # (1) of the duplicated data management table 1100.

The management computer returns to FIG. 12, and repeats the relocation processing (step 1210 to step 1214) for the number of entries (duplicated data #) of the duplicated data management table 1100 (step 1206, step 1218). The management computer 104 also repeats the relocation processing for the number of host computers (shown with reference numeral 1008 of FIG. 10) belonging to the duplicated block group registered in the entry (duplicated data #) of the duplicated data management table 1100 (step 1208, step 1216).

At step 1210, the management computer 104 confirms whether an unused area of a size of the duplicated block group exists from the address of the virtual volume corresponding to the top of the virtual page so that the duplicated data in the total size of the duplicated block group registered in the duplicated data management table 1100 can be written from the top of the virtual page from the host computer 102. Whether there is such unused area is determined by the management computer based on the file management table acquired at step 1002.

If the management computer 104 obtains a negative result in the determination at step 1210, it orders the agent 124 of the host computer 102 to further migrate data of an arbitrary virtual page, which is not a relocation destination of the duplicated data, to another virtual page in order to secure the required capacity for relocating the duplicated data to the virtual volume (step 1212).

Subsequently, the management computer 104 commands the agent 124 of the respective host computers 102 to convert the top address of the virtual page to become the relocation destination of the duplicated data into a LUN address, and cause the re-spective host computers 102 to write the duplicated block from the top address in order as designated in the duplicated data management table (step 1214). The management computer 104 further sends a command to the storage subsystem for releasing the mapping of the physical page to the virtual page to which the duplicated data has been previously written.

According to step 1214, the duplicated data is placed from the top of the page, which is the de-duplication unit. Accordingly, the de-duplication engine 200 of the storage subsystem is thereby able to realize the de-duplication processing regarding the plurality of physical pages since duplicated data exists in the plurality of physical pages according to the same placement. For example, since the image of duplicated data to be respectively stored in the virtual page #1 of the virtual volume #1 to be accessed by the host #11, the virtual page #2 of the virtual volume #2 to be accessed by the host #12, and the virtual page #3 of the virtual volume #2 to be accessed by the host #13 will be [aaaaaaabbbbbbbccccccc . . . ], de-duplication processing is achieved regarding the physical pages assigned to each off the plurality of virtual pages.

If the unused capacity at the save destination is insufficient at step 1210, the storage subsystem temporarily stores the save data in an area of the main memory, and, after the relocation of the duplicated data, the save data may be re-written to an unused area of the storage resource.

At step 1214, if the management computer 104 determines that there is a possibility that small amount of data may be distributed to a plurality of physical pages due to the relocation of duplicated data, it may cause the host computer 102 to implement, via the agent 124, a de-flag to the file blocks that were not subject to the relocation. De-flag means the processing of migrating the file block storing the data to an unused area of the LUN address that is farther out front.

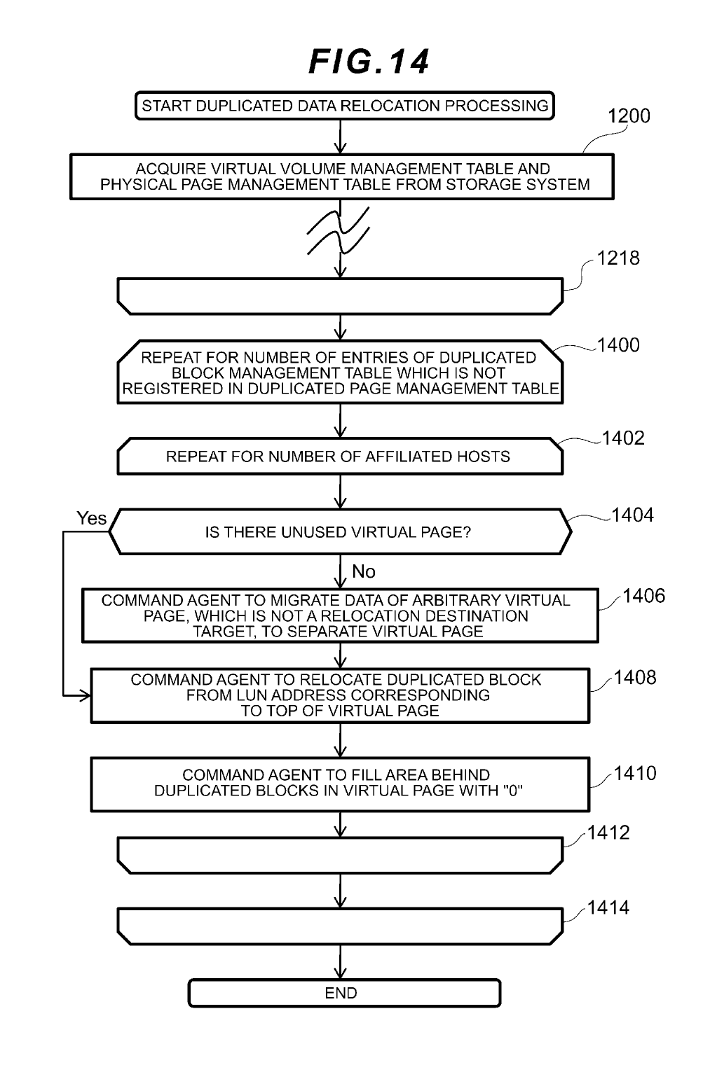

FIG. 14 is a flowchart showing an extended example of the foregoing duplicated data relocation processing of FIG. 12. If the management computer 104 is unable to set a combination of the duplicated block groups to become greater than the physical page (1308, 1310 of FIG. 13), the de-duplication processing is realized among a plurality of physical pages by filling data in all areas of the page by writing [0], which is specific data, in the areas of the address after the duplicated data in that page.

Step 1200 to step 1218 are the same as FIG. 12. Step 1401 and step 1418 mean that the management computer repeats step 1400 to step 1410 for the number of entries (duplicated block group #) of the duplicated block management table 1000 not registered in the duplicated page management table 1100. Step 1402 and step 1412 mean that the management computer 104 repeats step 1404 to step 1410 for the number of hosts (1008) belonging to the duplicated block group.

The management computer 104 refers to the virtual volume management table 300, and determines whether there is any unused virtual page 304 to which a physical page has not been assigned (step 1404). If the management computer 104 determines that there is no unused virtual page, as with foregoing step 1212, it creates an unused virtual page (step 1406). Step 1408 is the same as foregoing step 1214, and implements the duplicated data relocation processing of writing data of a duplicated block in the virtual page. At step 1410, the management computer 104 commands the agent 124 of the host computer 104 to cause the host computer 102 to write [0] in the areas behind the duplicated block in the virtual page.

In the embodiment explained above, although the relocation of duplicated data was implemented to the size of the virtual page, which is the de-duplication unit, it is also possible to perform relocation of the duplicated data to the de-duplication unit * n (here n is an integer of 2 or higher), and thereafter implementing the de-duplication processing of duplicated data. If the write unit is greater than the de-duplication unit, a plurality of de-duplication units must be treated as a single unit.

Another embodiment of the present invention is now explained. In the foregoing embodiment, the storage subsystem performed the relocation of duplicated data based on the writing from the host computer, this embodiment is characterized in that the storage subsystem performed the duplicated data relocation processing based on a command from the management computer.

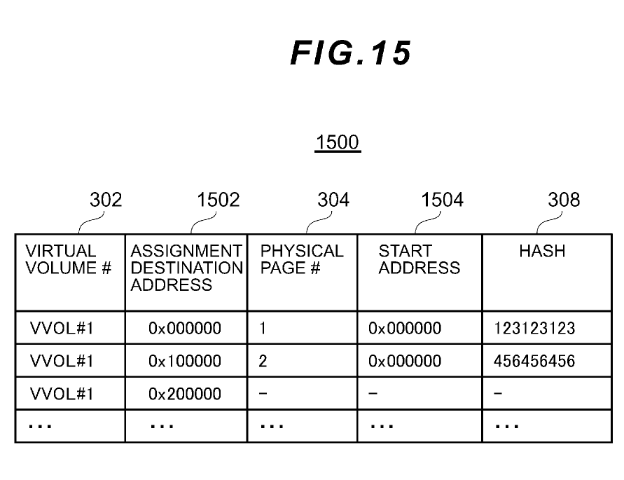

FIG. 15 shows the virtual volume management table 1500 for implementing this embodiment, and an assignment destination address 1502 and a start address 1504 have been added to the foregoing virtual volume management table 300. The assignment destination address 1502 is the top address to which the physical page is to be assigned in the virtual volume, and the start address 1504 is the start address of the physical page to be assigned to the virtual volume.

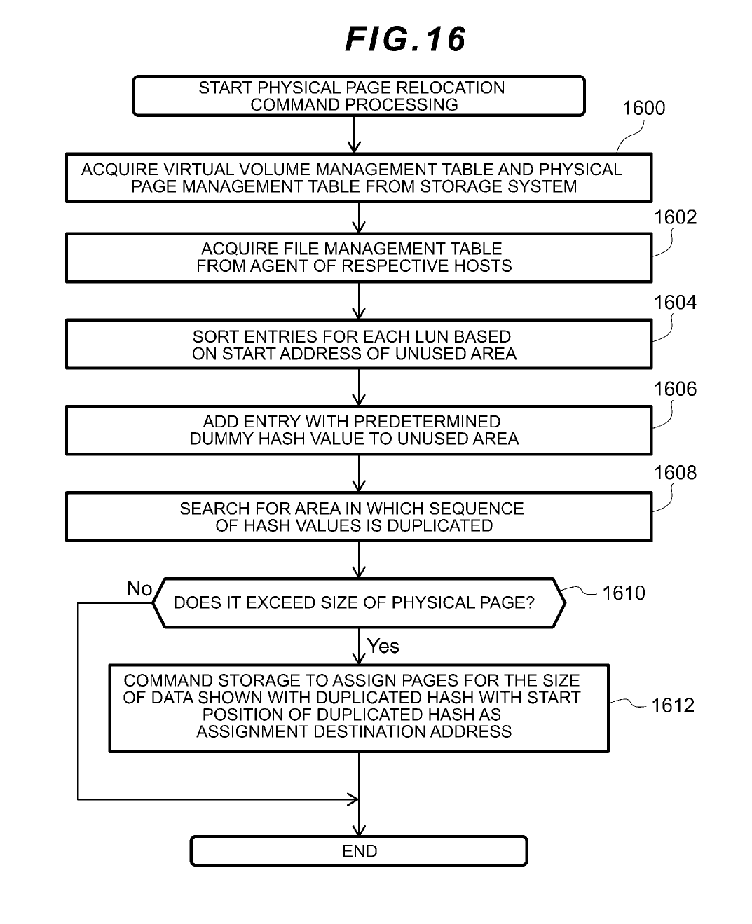

FIG. 16 is a flowchart showing the physical page relocation processing in the storage subsystem 100 based on the management software 122. This flowchart is started based on a command from the management user or a command from the scheduler. At step 1600, the management computer 104 acquires the virtual volume management table 1500 and the physical page management table 400 from the storage subsystem 100.

Subsequently, the management apparatus 104 acquires the file management table from the agent 124 of the respective host computers 102 (step 1602). The management computer 104 thereafter sorts the file management table based on the start address 908 for each LUN # (906) (1604). For addresses without any entry in the LUN # (906), a predetermined dummy hash such as 0000 is created to realize a hash list associated with the overall LU for each LUN # (1606).

Subsequently, the management computer 104 searches for areas of the virtual volume in which the alignment of the hash value is a match (step 1608). The management computer 104 determines whether the series of areas in which the hash value is a match exceeds the size of the physical page (step 1610), and, upon obtaining a positive result in the foregoing determination, sets the start address of the area with a duplicated hash value as the assignment destination address of the physical page, and commands the storage subsystem 100 to assign a physical page in the size of data corresponding to the duplicated hash value (step 1612).

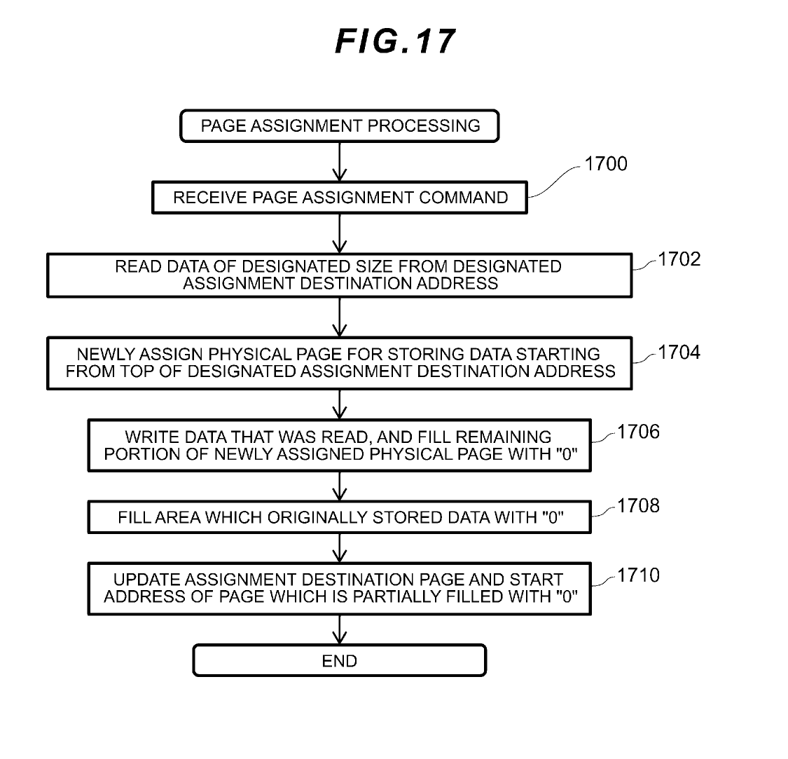

When the management computer 104 completes step 1506, the storage subsystem 100 starts the flowchart of FIG. 17 and starts the physical page assignment processing for relocating the duplicated data. When the de-duplication engine 200 receives a physical page assignment command from the management computer 104 (step 1700), the de-duplication engine 200 reads data in the size designated by the designated assignment destination address (step 1702).

The de-duplication engine 200 newly assigns, to the virtual volume, physical pages of a number capable of storing the size of the read data (step 1704). Here, the top address of the virtual volume to which the top physical page is assigned is set as the assignment destination address 1502 in FIG. 15. At step 1704, the value obtained by adding the size of the physical page is registered in the assignment destination address of the virtual volume with the de-duplication engine 200 according to the order of the physical volumes newly assigned to the virtual volume.

The de-duplication engine 200 writes the data read at step 1702 from the top of the physical page to the physical pages assigned to the virtual volume. [0] is stored in the remaining portions of the physical page where data is not written. The de-duplication engine 200 fills specific data [0] into the areas where data read at step 1702 was originally stored. Since the physical pages partially filled with [0] at step 1708 are valid data for sections after the portions filled with [0], the assignment destination address 1502 of the virtual volume management table is updated with the address subsequent to the last address filled with [0] in the virtual volume, and the start address 1504 is updated with the address subsequent to the last address of the physical page filled with [0].

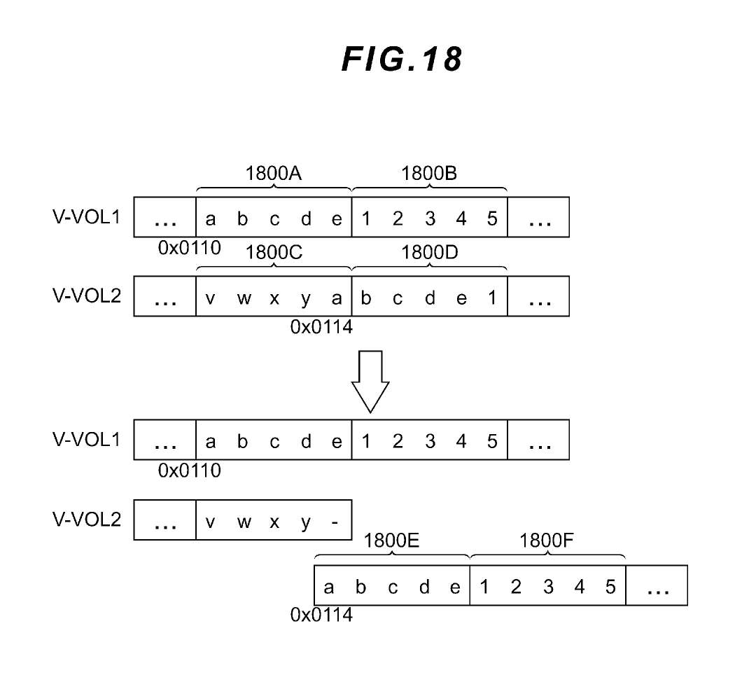

If a duplicated file exceeding the size of the de-duplication unit is stored in the virtual volume V-VOL 1 and the virtual volume V-VOL 2 as shown in FIG. 18, de-duplication was not executed since the sequence of duplicated data did not coincide as shown with the de-duplication unit 1800A and the de-duplication unit 1800C, and as with the de-duplication unit 1800B and the de-duplication unit 1800D. However, with the de-duplication processing of FIG. 16 and FIG. 17, since the physical page is assigned to the virtual volume so that the start location of the duplicated data in the virtual volume V-VOL 2 becomes the start location (0x0114) of the de-duplication unit, the sequence of the duplicated data relative to the de-duplication unit in the virtual volume V-VOL 2 can be made to be the same sequence of the duplicated data in the virtual volume V-VOL 1 as shown with 1800E and 1800F. Thus, the storage subsystem 100 is able to execute de-duplication processing to a plurality of physical volumes respectively storing duplicated data in the pool 220.

### REFERENCE SIGNS LIST

100 Storage subsystem

102 Host computer

104 Management apparatus

114 Controller

212 Virtual volume

220 Page-use real volume

1. A computer system, comprising:
a storage resource for storing write data sent from a host computer;
a controller for controlling assignment of the storage resource to the write data; and
a management apparatus for managing the storage resource assigned to the write data, and
the controller determines whether a plurality of write data stored in the storage resource are mutually the same, and, upon obtaining a positive result in the determination, prevents the storage resource from being redundantly assigned to the same write data,
wherein the management apparatus:
detects the same write data;
acquires a management size from the controller for the determination; and
relocates the same write data to the storage resource based on the management size.

2. The computer system according to claim 1,
wherein the management apparatus causes the controller to execute the relocation for storing the mutually same data in the storage resource so that each of the mutually same data is arranged in the same manner based on the management size.

3. The computer system according to claim 2,
wherein the management apparatus causes the controller to execute the relocation for storing the mutually same data in the storage resource so that a start location of each of the mutually same data becomes a start location of the management size.

4. The computer system according to claim 3,
wherein the computer system comprises a storage subsystem including the storage resource and the controller, and the host computer, and
wherein the storage subsystem comprises:
a first interface for connecting to the host computer;
a second interface for connecting to a storage device providing the storage resource; and
a third interface for connecting to the management apparatus.

5. The computer system according to claim 4,
wherein the controller:
sets a virtual volume to be accessed by the host computer;
assigns a physical page from the storage resource to a virtual page of the virtual volume if the host computer writes into the virtual page of the virtual volume, and stores the write data in the physical page; and
sets the management size to a size of the virtual page.

6. The computer system according to claim 4,
wherein the management apparatus:
acquires management information from the host computer and detects the same data;
indicates a storage location of the same data in the storage resource to the host computer; and
the host apparatus outputs a write request to the controller for setting the same data in the storage location.

7. The computer system according to claim 4,
wherein the management apparatus:
acquires management information from the host computer and detects the same data;
indicates a storage location of the same data in the storage resource to the controller; and
the controller sets the same data in the storage location.

8. The computer system according to claim 5,
wherein the management apparatus:
acquires management information from a plurality of host apparatuses;
detects a plurality of the same data from the management information;
decides a combination of the plurality of same data to achieve a size of the page; and
executes the relocation to the storage resource of the plurality of same data so that the combination of the plurality of same data is stored from the start location of the page.

9. The computer system according to claim 8,
wherein the management apparatus obtains insufficiency of the combination size of the plurality of same data according to the combination relative to the page size, and stores predetermined data in an area of the page corresponding to the insufficiency.
